(19) United States
(12) Patent Application Publication
(10) Pub. No.: US 2023/0347781 A1
(43) Pub. Date: Nov. 2, 2023

(54) CHARGING MANAGEMENT METHODS AND SYSTEMS FOR ELECTRIC VEHICLE CHARGING STATIONS

(71) Applicant: Noodoe Corporation, Taipei City (TW)

(72) Inventors: Yi-An Hou, Taipei City (TW); Chun-Hung Kung, Taipei City (TW)

(21) Appl. No.: 18/164,659

(22) Filed: Feb. 6, 2023

(30) Foreign Application Priority Data
Apr. 27, 2022 (TW) 111116082

(51) Int. Cl. B60L 53/66; B60L 53/65

(52) U.S. Cl. CPC B60L 53/665; B60L 53/65; B60L 2240/70

(57) ABSTRACT

Charging management methods and systems for electric vehicle charging stations for use in a server are provided. First, at least one electric vehicle performs at least one charging operation at an electric vehicle charging station, thereby generating at least one charging data. Then, the server receives the at least one charging data corresponding to the at least one charging operation through a network, and analyzes a usage index corresponding to the electric vehicle charging station according to the at least one charging data.

### BACKGROUND OF THE INVENTION

### Field of the Invention

The disclosure relates generally to charging management methods and systems for electric vehicle charging stations, and, more particularly to methods and system that can analyze and calculate rewards based on the usage status of electric vehicle charging stations.

### Description of the Related Art

Recently, with the rising awareness of environmental protection and electric vehicle technology advances, the development of electric vehicles powered by electrical energy to replace traditional vehicles powered by fossil fuels has gradually become an important goal in the automotive field, thus making electric vehicles become more and more popular. In order to increase the range and willingness to use electric vehicles, many countries or cities have begun to set up charging stations in public places to provide electricity to electric vehicles, and have also begun to plan the deployment of a large number of charging stations in urban areas or scenic areas, so as to make the charging of electric vehicles more convenient.

Generally, the construction of electric vehicle charging stations requires high costs. Therefore, in addition to private operators setting up electric vehicle charging stations themselves, the role and thrust played by the government have become an important key to the development of electric vehicles. In view of this, many governments will use subsidy policies to encourage private operators to actively setup electric vehicle charging stations in the early stages of electric vehicle development, so as to reduce the mileage anxiety of electric vehicle driving.

However, in the case of policy subsidies, relevant government units often need to know the usage status of electric vehicle charging stations, such as their utilization rates, so as to further evaluate the effect of policy subsidies and perform follow-up policy adjustment evaluation. On the other hand, after receiving government subsidies, some operators did not carry out effective maintenance and operation of electric vehicle charging stations, and even closed electric vehicle charging stations to avoid additional costs, which led to user dissatisfaction and lost the good intentions for the government to subside the setting of electric vehicle charging stations.

### BRIEF SUMMARY OF THE INVENTION

In an embodiment of a charging management method for electric vehicle charging stations for use in a server, at least one electric vehicle first performs at least one charging operation at an electric vehicle charging station, thereby generating at least one charging data. Then, the server receives the at least one charging data corresponding to the at least one charging operation through a network, and analyzes a usage index corresponding to the electric vehicle charging station according to the at least one charging data.

An embodiment of a charging management system for electric vehicle charging stations comprises an electric vehicle charging station and a server. The electric vehicle charging station provides at least one electric vehicle to perform at least one charging operation, thereby generating at least one charging data. The server receives the at least one charging data corresponding to the at least one charging operation through a network, and analyzes a usage index corresponding to the electric vehicle charging station according to the at least one charging data.

In some embodiments, a charging station usage reward for a charging point operator (CPO) corresponding to the electric vehicle charging station is calculated based on the usage index.

In some embodiments, the at least one charging data is received by the charging point operator through the network, and the server belongs to a charging roaming management platform.

In some embodiments, a charging fee is calculated based on the at least one charging data, identification data corresponding to the electric vehicle or an owner of the electric vehicle is received through the network, and an account offset operation is executed based on the identification data, wherein the account offset operation includes the steps of searching a stored value database according to the identification data to obtain an account balance corresponding to the identification data, and deducting the charging fee from the account balance until the account balance becomes zero.

In some embodiments, it is determined whether the electric vehicle or the owner of the electric vehicle meets a predetermined identity based on the identification data. When the electric vehicle or the owner of the electric vehicle meets the predetermined identity, the account offset operation is executed.

In some embodiments, the identification data corresponding to the electric vehicle or the owner of the electric vehicle is received from an E-mobility service provider (EMSP) through the network, and the server belongs to a charging roaming management platform.

In some embodiments, a compensation content of the E-mobility service provider is calculated based on the charging fee of the identification data.

In some embodiments, the usage index comprises a usage status during peak hours, a usage status during off-peak hours, or an implementation status of demand response.

In some embodiments, identification data corresponding to the electric vehicle is received through the network, mileage data of the electric vehicle is received and recorded through the network, and a vehicle mileage reward corresponding to the electric vehicle is calculated based on the identification data and the mileage data.

Charging management methods for electric vehicle charging stations may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a charging management system for electric vehicle charging stations of the invention;

FIG. 2 is a schematic diagram illustrating another embodiment of a charging management system for electric vehicle charging stations of the invention;

FIG. 3 is a schematic diagram illustrating another embodiment of a charging management system for electric vehicle charging stations of the invention;

FIG. 4 is a schematic diagram illustrating an embodiment of an electric vehicle charging station of the invention;

FIG. 5 is a schematic diagram illustrating an embodiment of a server of the invention;

FIG. 6 is a flowchart of an embodiment of a charging management method for electric vehicle charging stations of the invention;

FIG. 7 is a flowchart of another embodiment of a charging management method for electric vehicle charging stations of the invention;

FIG. 8 is a flowchart of another embodiment of a charging management method for electric vehicle charging stations of the invention;

FIG. 9 is a flowchart of an embodiment of an account offset method of the invention; and

FIG. 10 is a flowchart of another embodiment of a charging management method for electric vehicle charging stations of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

FIG. 1 is a schematic diagram illustrating an embodiment of a charging management system for electric vehicle charging stations of the invention. The charging management system for electric vehicle charging stations 100 comprises at least one electric vehicle charging station 110, and a server 120 coupled to the electric vehicle charging station 110 via a network 130. The electric vehicle charging station may provide a charging operation for electric vehicles. The server 120 may communicate with the electric vehicle charging station 110 via the network 130 to receive information about the electric vehicle charging station 110, information about the corresponding charging operations of the electric vehicle charging station 110 and so on, and execute the charging management method for electric vehicle charging stations of the invention. The relevant details will be described later. In some embodiments, the network 130 may be a wired network, a telecommunication network, and a wireless network, such as a Wi-Fi network.

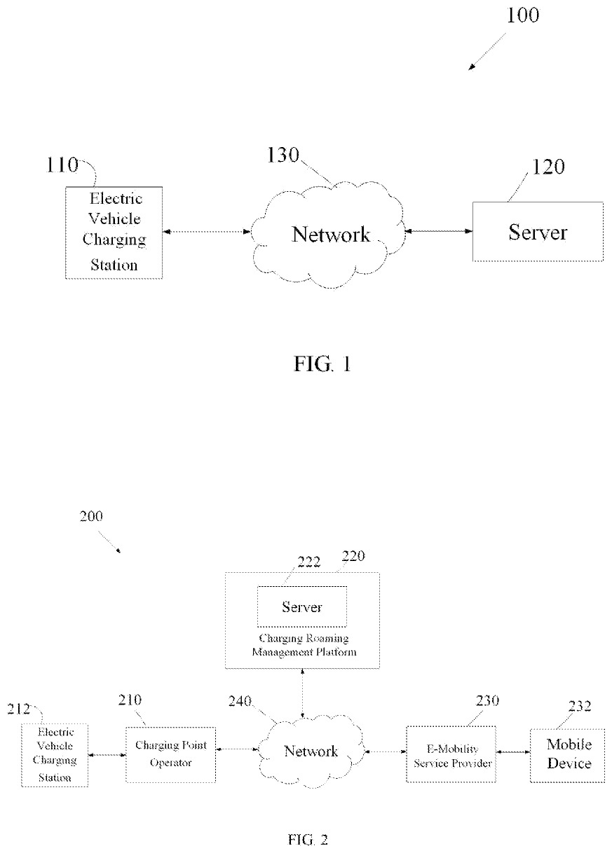

FIG. 2 is a schematic diagram illustrating another embodiment of a charging management system for electric vehicle charging stations of the invention. The charging management system for electric vehicle charging stations 200 comprises a charging point operator (CPO) or charging station operator 210, a charging roaming management platform 220 and an E-mobility service provider (eMSP) 230. It is understood that the charging point operator (CPO) or charging station operator can also be referred to as the charging station operator. Note that the charging point operator 210 and the E-mobility service provider 230 can be coupled to the charging roaming management platform 220 through a network 240. In some embodiments, the network 240 may be a wired network, a telecommunication network, and a wireless network, such as a Wi-Fi network. The charging point operator 210 can perform related charging management operations for at least one electric vehicle charging station 212 through the network, and the electric vehicle charging station 212 can provide electric vehicles for a charging operation. It is noted that the at least one electric vehicle charging station 212 may be located in one or different charging areas. The charging roaming management platform 220 may include a server 222 for communicating with the charging point operator 210 to receive information about the electric vehicle charging station 212, information about the corresponding charging operations and other information from the charging point operator 210 via the network 240. The E-mobility service provider 230 can provide its members with the ability to use a mobile device 232 to perform roaming charging of electric vehicles across charging point operators. In some embodiments, the E-mobility service provider 230 and the charging point operator 210 may sign a contract to carry out a charging agreement, etc., and perform roaming charging of electric vehicles through the charging roaming management platform 220. When members of the E-mobility service provider 230 use the mobile device 232 to charge their electric vehicles at the electric vehicle charging station 212 of the charging point operator 210, the certification operation for the respective charging operation will be performed by the E-mobility service provider 230, and then notifies the charging point operator 210 to control the electric vehicle charging station 212 to perform the charging operation through the charging roaming management platform 220. The server 222 of the charging roaming management platform 220 can communicate with the charging point operator 210 through the network 240 to receive relevant information about the charging operation performed by the corresponding electric vehicle charging station 212 from the charging point operator 210. It should be noted that, the charging roaming management platform 220, the charging point operator 210, and the E-mobility service provider 230 can implement relevant roaming protocols/agreements to obtain relevant charging station information and related information for the corresponding charging operation.

It is noted that the charging point operator can have a management server to receive various data from respective electric vehicle charging stations through the network, and transmit related signals to the electric vehicle charging stations through the network. The electric vehicle charging stations can perform related operations according to the signals received from the manager server. For example, when an electric vehicle is coupled to the electric vehicle charging station through a charging gun of the electric vehicle charging station for a charging operation, the electric vehicle charging station can continuously transmit charging information corresponding the charging operation of respective electric vehicle via the network, and the manager server can receive the charging information of the corresponding charging operation from the electric vehicle charging station via the network.

It is noted that the user can connect the electric vehicle and the electric vehicle charging station to each other, such as inserting a charging gun into the charging port of the electric vehicle to send a charging request corresponding to the electric vehicle charging station to use the electric vehicle charging station to perform a charging operation for the electric vehicle. It is understood that, in some embodiments, the manager server of the charging point operator may directly or indirectly receive a charging request from a mobile device of the owner of the electric vehicle, and generate a charging authorization command based on the charging request and transmit it to the electric vehicle charging station via the network, so that the electric vehicle charging station outputs power to the electric vehicle, such as an electric scooter or an electric car, which is electrically connected to it, or prohibits the electric vehicle charging station from outputting power to the electric vehicle. It is reminded that, in some embodiments, the charging request may be accompanied by an identity authentication and/or a payment mechanism, and the charging authorization command will only be generated after the identity authentication and/or payment mechanism is completed. As aforementioned, in some embodiments, the identity authentication and/or payment mechanism may be performed by the E-mobility service provider. In some embodiments, the user of the electric vehicle can use his/her mobile device to download and install an application to generate a charging request through the user interface of the application. In some embodiments, the user can scan a Quick Response Code (QR code) on the electric vehicle charging station through the scanning function of the application to generate the above-mentioned charging request, thereby starting a charging operation. In some embodiments, the user can select a specific charging station through the application and execute an activation function to generate the above-mentioned charging request, thereby starting a charging operation. It is understood that, in some embodiments, the owner of the electric vehicle can use an RFID card to approach an induction area (not shown in FIG. 2) on the electric vehicle charging station to generate a corresponding charging request, and sent it to the manager server via the network. It is reminded that, in some embodiments, each user (the owner of the electric vehicle) can have an RFID card. It is noted that, in some embodiments, the owner of the electric vehicle may be a member of the E-mobility service provider and wish to query the charging point operators and their electric vehicle charging stations for roaming charging through the interface provided by the E-mobility service provider.

It is noted that, the mobile device 232 of the owner of the electric vehicle can be any electronic device capable of Internet access, such as mobile devices, such as mobile phones, smart phones, personal digital assistants, global positioning systems, and notebook computers. In some embodiments, the mobile device 232 can receive status information and notifications of the corresponding charging operation from the E-mobility service provider 230 via the network. In some embodiments, the status information and notification may include notifying that the electric vehicle has stopped charging, notifying that the vehicle needed to be moved, and/or notifying that the charging gun of the electric vehicle charging device has been disconnected from the electric vehicle, and so on.

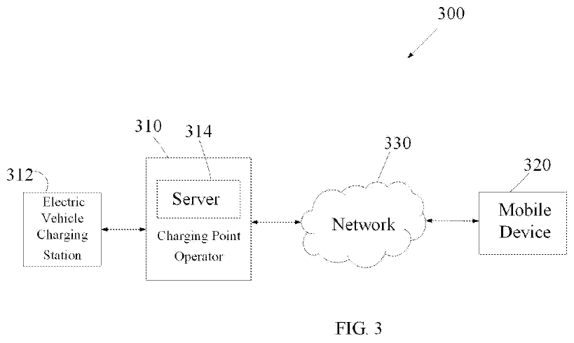

FIG. 3 is a schematic diagram illustrating another embodiment of a charging management system for electric vehicle charging stations of the invention. In this embodiment, a charging point operator can also be an E-mobility service provider. The charging management system for electric vehicle charging stations 300 comprises a charging point operator (CPO) 310 and a mobile device 320. Note that the mobile device 320 can be coupled to the charging point operator 310 through a network 330. In some embodiments, the network 330 may be a wired network, a telecommunication network, and a wireless network, such as a Wi-Fi network. The charging point operator 310 can have a server 314 and perform related charging management operations for at least one electric vehicle charging station 312 through the network, and the electric vehicle charging station 312 can provide electric vehicles for a charging operation. It is noted that the at least one electric vehicle charging station 312 may be located in one or different charging areas. The server 314 can receive information about the electric vehicle charging station 312, information about the corresponding charging operations and other information via the network 330. The server 314 can provide members of the charging point operator 310 or members of other charging point operators with the ability to use the mobile device 320 to perform roaming charging of electric vehicles across charging point operators. In some embodiments, the charging point operator 310 and other charging point operators may sign a contract to carry out a charging agreement of the charging fee, or the like. It is noted that, when the members of other charging point operators use the mobile device 320 to charge their electric vehicles at the electric vehicle charging station 312 of the charging point operator 310, the certification operations for the respective charging operations will be performed by their original charging point operators, and then they notify the charging point operator 310 to control the electric vehicle charging station 312 to perform the charging operation. The server 314 of the charging point operator 310 can receive relevant information about the charging operation performed by the corresponding electric vehicle charging station 312. It is noted that, the mobile device 320 of the owner of the electric vehicle can be any electronic device capable of Internet access, such as mobile devices, such as mobile phones, smart phones, personal digital assistants, global positioning systems, and notebook computers. In some embodiments, the mobile device 320 can receive status information and notifications of the corresponding charging operation from the server 314 via the network. In some embodiments, the status information and notification may include notifying that the electric vehicle has stopped charging, notifying that the vehicle needed to be moved, and/or notifying that the charging gun of the electric vehicle charging device has been disconnected from the electric vehicle, and so on.

As mentioned above, the server 314 of the charging point operator 310 can receive various data from respective electric vehicle charging stations through the network, and transmit related signals to the electric vehicle charging stations through the network. The electric vehicle charging stations can perform related operations according to the signals received from the server 314. For example, when an electric vehicle is coupled to the electric vehicle charging station through a charging gun of the electric vehicle charging station for a charging operation, the electric vehicle charging station can continuously transmit charging information corresponding the charging operation of respective electric vehicle via the network, and the server 314 can receive the charging information of the corresponding charging operation from the electric vehicle charging station via the network.

Similarly, the user can connect the electric vehicle and the electric vehicle charging station to each other, such as inserting a charging gun into the charging port of the electric vehicle to send a charging request corresponding to the electric vehicle charging station to use the electric vehicle charging station to perform a charging operation for the electric vehicle. It is understood that, in some embodiments, the server of the charging point operator may directly or indirectly receive a charging request from a mobile device of the owner of the electric vehicle, and generate a charging authorization command based on the charging request and transmit it to the electric vehicle charging station via the network, so that the electric vehicle charging station outputs power to the electric vehicle, such as an electric scooter or an electric car, which is electrically connected to it, or prohibits the electric vehicle charging station from outputting power to the electric vehicle. It is reminded that, in some embodiments, the charging request may be accompanied by an identity authentication and/or a payment mechanism, and the charging authorization command will only be generated after the identity authentication and/or payment mechanism is completed. As aforementioned, in some embodiments, the identity authentication and/or payment mechanism may be performed by the E-mobility service provider. In some embodiments, the user of the electric vehicle can use his/her mobile device to download and install an application to generate a charging request through the user interface of the application. In some embodiments, the user can scan a Quick Response Code (QR code) on the electric vehicle charging station through the scanning function of the application to generate the above-mentioned charging request, thereby starting a charging operation. In some embodiments, the user can select a specific charging station through the application and execute an activation function to generate the above-mentioned charging request, thereby starting a charging operation. It is understood that, in some embodiments, the owner of the electric vehicle can use an RFID card to approach an induction area (not shown in FIG. 3) on the electric vehicle charging station to generate a corresponding charging request, and sent it to the manager server via the network. It is reminded that, in some embodiments, each user (the owner of the electric vehicle) can have an RFID card. It is noted that, in some embodiments, the owner of the electric vehicle may be a member of the E-mobility service provider and wish to query the charging point operators and their electric vehicle charging stations for roaming charging through the interface provided by the E-mobility service provider.

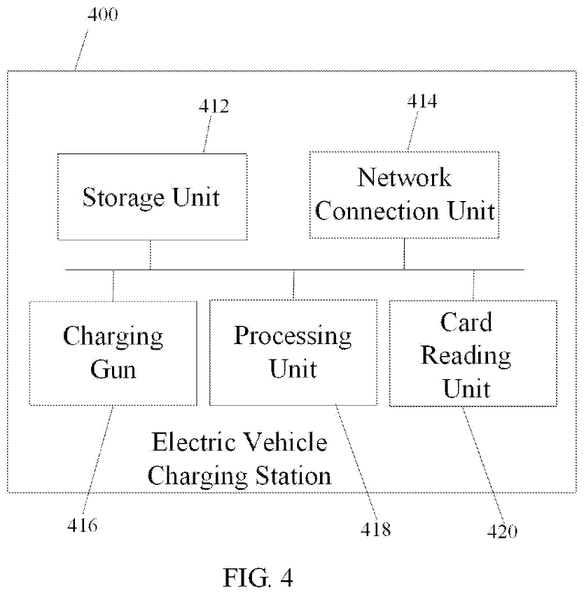

FIG. 4 is a schematic diagram illustrating an embodiment of an electric vehicle charging station of the invention. The electric vehicle charging station 400 shown in FIG. 4 can be applied to the electric vehicle charging stations (110, 212, 312) in FIG. 1, FIG. 2 or FIG. 3, which has processing and computing capabilities to perform charging management operations for the electric vehicle charging station. The electric vehicle charging station 400 has a network connection capability to receive, download or update various parameters and information required for charging management calculations.

The electric vehicle charging station 400 at least comprises a storage unit 412, a network connection unit 414, a charging gun 416, a processing unit 418, and a card reading unit 420. The storage unit 412 may be a memory or a database for storing and recording related data. The data may be related information such as charging station ID of the electric vehicle charging station and charging requests. It should be noted that the aforementioned information is only example, and the invention is not limited thereto. The network connection unit 414 can use a network, such as a wired network, a telecommunications network, and a wireless network, such as a Wi-Fi network, to receive, download, or update various parameters and information required for charging management operations. The charging gun 416 may include one or more charging connectors that meet the same charging interface specification or meet different charging interface specifications, and are electrically connected to the corresponding electric vehicle. The processing unit 418 can control the operations of related software and hardware in the electric vehicle charging station 400. It is noted that, in some embodiments, the processing unit 418 may be a general-purpose controller, a Micro-Control Unit, MCU, or a Digital Signal Processor, DSP, etc., to provide functions of data analysis, processing and calculation, but the present invention is not limited thereto. In one embodiment, the processing unit 418 may use the network connection unit 414 to transmit the power state of the corresponding electric vehicle through a network for a cloud management server for subsequent charging management. In another embodiment, the processing unit 418 can obtain the power parameter of a charging operation from the manager server, determine the output power according to the power parameter received from the manager server, and output the power to at least one electric vehicle through the charging gun 416 to perform the charging operation. The card reading unit 420 may be an RFID reading unit for sensing information of a physical card, such as RFID card. The information sensed from the RFID card may be a card identification code of the physical card.

It is understood that, the electric vehicle charging station 400 has an upper power limit value and a lower power limit value. Specifically, the electric vehicle charging station 400 can use the upper power limit value as the power parameter at the highest to output power to the electric vehicle during a charging operation. On the other hand, the electric vehicle charging station 400 needs to use the lower power limit value as the power parameter at least to output power to the electric vehicle during a charging operation. It must be noted that, charging stations of different brands and models may have different upper power limit values for output power and lower power limit values for output power. The present invention is not limited to any value, and the value may be different for different charging stations.

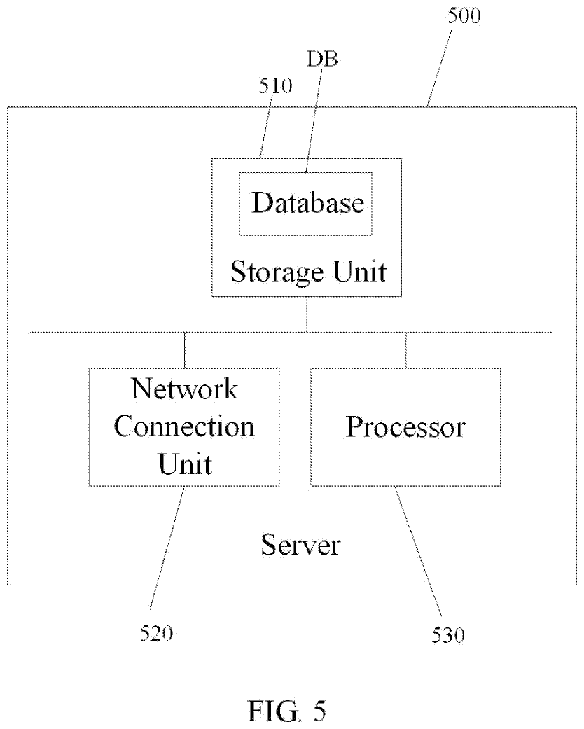

FIG. 5 is a schematic diagram illustrating an embodiment of a server of the invention. It is noted that the server 500 in FIG. 5 can be applied to the servers (120, 222, 314) in FIG. 1, FIG. 2 or FIG. 3. As shown in FIG. 5, the server 500 of the invention can be any processor-based electronic device, which comprises at least a storage unit 510, a network connection unit 520, and a processor 530. It is noted that, the server 500 can receive various data corresponding to a plurality of electric vehicle charging stations in individual charging fields from the charging point operators. The server 500 can directly or indirectly receive a charging request from a mobile device, and after completing actions such as identity confirmation in response to the charging request, generate a charging authorization command and transmit it to the corresponding electric vehicle charging station via the network. In response to the charging authorization command, the electric vehicle charging station is allowed to output power to an electric vehicle (for example, an electric motorcycle or an electric vehicle, etc.) that is electrically connected to it, or prohibit the electric vehicle charging station from outputting power to the electric vehicle.

The storage unit 510 may be a memory comprising a database DB, which can store and record related data, such as various data of the charging point operators/the electric vehicle charging stations. It is noted that when the server is located on the charging roaming management platform, the database DB also records the related information corresponding to the E-mobility service provider. In addition, in some embodiments, the database DB can also record corresponding different charging point operators, E-mobility service providers, users, and their respective identification codes. In some embodiments, the database DB may record the formats and fields of charging station data corresponding to different charging point operators. Through the network connection unit 520, the server 500 can be coupled to and communicates with the charging point operators/electric vehicle charging stations/electric mobile service providers via the network, such as a wired network, a telecommunications network, and a wireless network, such as a Wi-Fi network, and transmits related data/signals/commands to different charging point operators/electric vehicle charging stations/electric mobile service providers via the network to control whether the electric vehicle charging stations output power, and specify power parameters for outputting power to electric vehicles. On the other hand, through the network connection unit 520, the server 500 can also be coupled and communicates with the mobile device via the network, and transmit related data/signals/commands to the mobile device via the network. The processor 530 can control the operations of related software and hardware in the server 500, and execute the charging management method for electric vehicle charging stations of the invention. The relevant details will be described later. It is understood that, in some embodiments, the processor 530 may be a general-purpose controller, a Micro-Control Unit, MCU, or a Digital Signal Processor, DSP, etc., to provide data analysis, processing, and calculation functions.

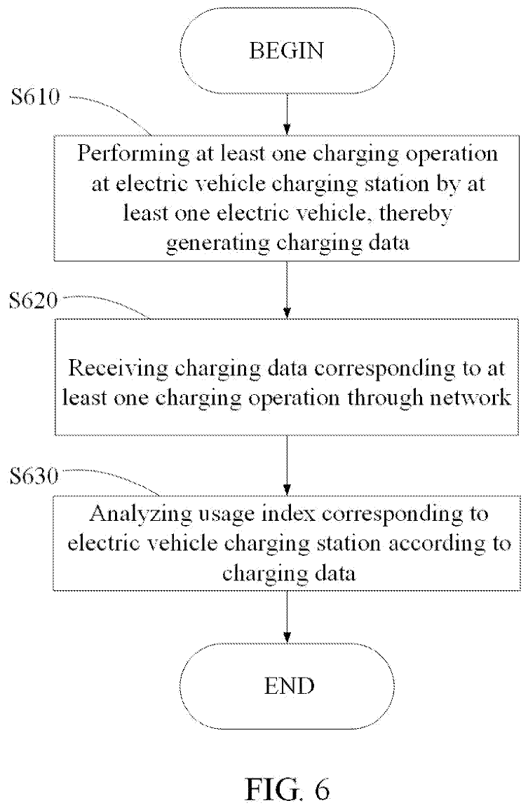

FIG. 6 is a flowchart of an embodiment of a charging management method for electric vehicle charging stations of the invention. The charging management method for electric vehicle charging stations of the invention can be applied to a server.

First, in step S610, at least one electric vehicle performs at least one charging operation at an electric vehicle charging station, thereby generating at least one charging data. It is noted that, in some embodiments, the charging data may include related data of the corresponding charging point operator and electric vehicle charging station, the charging power quantity corresponding to the charging operation, charging time interval, charging period, and/or demand response execution status, and so on. It should be noted that the aforementioned charging data is only example, and the invention is not limited thereto. Thereafter, in step S620, the at least one charging data corresponding to the at least one charging operation is received through a network. It should be understood that, in some embodiments, the charging data can be received by the charging point operator through the network, and the server belongs to a charging roaming management platform. Next, in step S630, a usage index corresponding to the electric vehicle charging station is analyzed according to the at least one charging data. It should be noted that, in some embodiments, the usage index may comprise a usage status during peak hours, a usage status during off-peak hours, or an implementation status of demand response. It should be noted that the aforementioned usage index is only example, and the invention is not limited thereto.

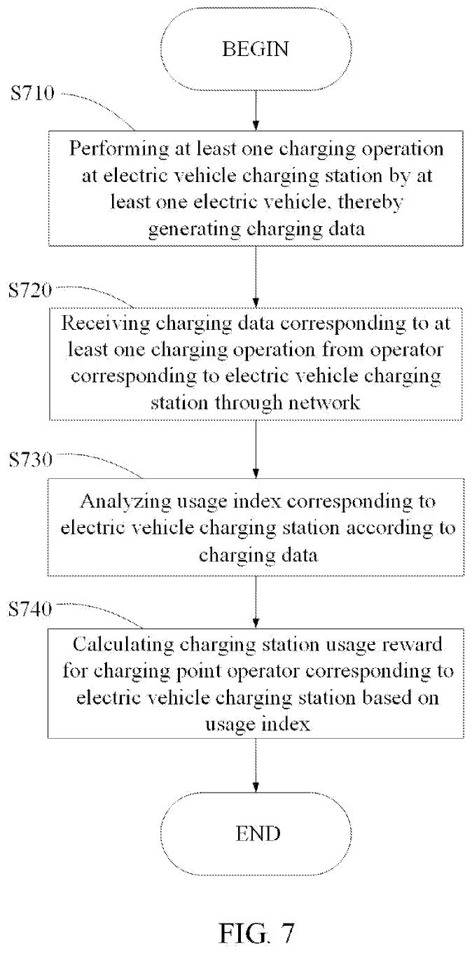

FIG. 7 is a flowchart of another embodiment of a charging management method for electric vehicle charging stations of the invention. The charging management method for electric vehicle charging stations of the invention can be applied to a server of a charging roaming management platform.

First, in step S710, at least one electric vehicle performs at least one charging operation at an electric vehicle charging station, thereby generating at least one charging data. Similarly, in some embodiments, the charging data may include related data of the corresponding charging point operator and electric vehicle charging station, the charging power quantity corresponding to the charging operation, charging time interval, charging period, and/or demand response execution status, and so on. It should be noted that the aforementioned charging data is only example, and the invention is not limited thereto. Thereafter, in step S720, the at least one charging data corresponding to the at least one charging operation is received from the operator corresponding to the electric vehicle charging station through a network. Next, in step S730, a usage index corresponding to the electric vehicle charging station is analyzed according to the at least one charging data. Similarly, in some embodiments, the usage index may comprise a usage status during peak hours, a usage status during off-peak hours, or an implementation status of demand response. It should be noted that the aforementioned usage index is only example, and the invention is not limited thereto. In step S740, a charging station usage reward for a charging point operator (CPO) corresponding to the electric vehicle charging station is calculated based on the usage index. It is noted that, in some embodiments, the charging station usage reward can be calculated based on a unit of reward money, and a total charging degree of electric vehicle charging stations of the corresponding operator, the degree of use during peak hours, the degree of use during off-peak hours, and/or the number of times the demand response is performed.

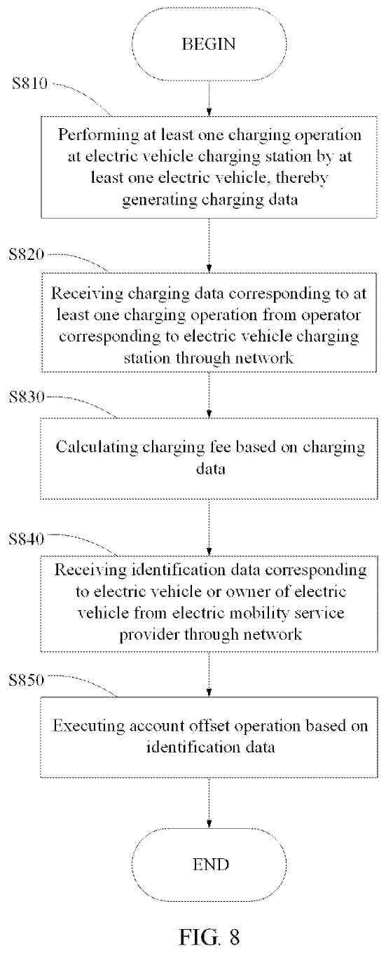

FIG. 8 is a flowchart of another embodiment of a charging management method for electric vehicle charging stations of the invention. The charging management method for electric vehicle charging stations of the invention can be applied to a server of a charging roaming management platform. In this embodiment, members (the owners of electric vehicles) of the E-mobility service provider can have an account offset function.

First, in step S810, at least one electric vehicle performs at least one charging operation at an electric vehicle charging station, thereby generating at least one charging data. Similarly, in some embodiments, the charging data may include related data of the corresponding charging point operator and electric vehicle charging station, the charging power quantity corresponding to the charging operation, charging time interval, charging period, and/or demand response execution status, and so on. It should be noted that the aforementioned charging data is only example, and the invention is not limited thereto. Thereafter, in step S820, the at least one charging data corresponding to the at least one charging operation is received from the operator corresponding to the electric vehicle charging station through a network, and in step S830, a charging fee is calculated based on the at least one charging data. Next, in step S840, identification data corresponding to the electric vehicle or an owner of the electric vehicle is received through the network. It should be noted that, in some embodiments, the identification data corresponding to the electric vehicle or that corresponding to the owner of the electric vehicle may be received from the E-mobility service provider through the network. Then, in step S850, an account offset operation is executed based on the identification data.

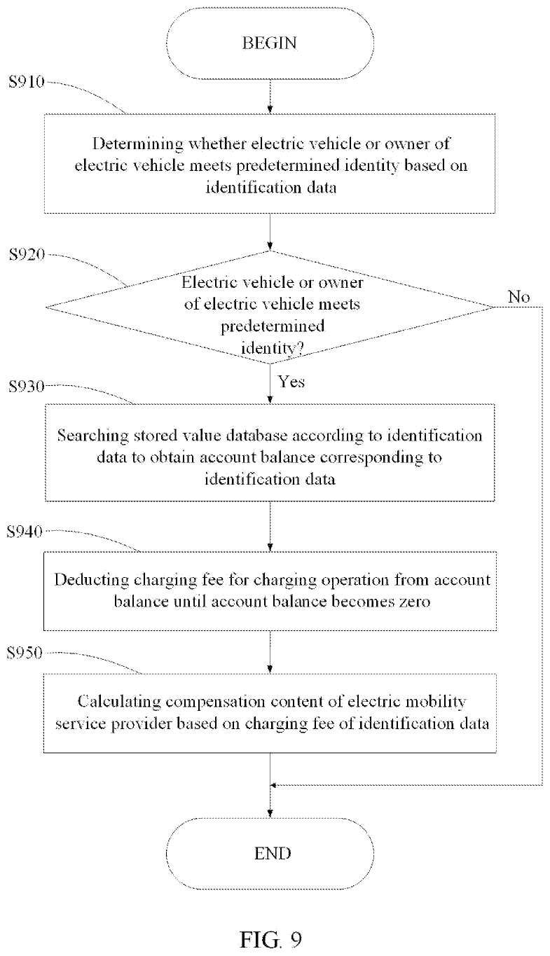

FIG. 9 is a flowchart of an embodiment of an account offset method of the invention. It is noted that, in some examples, the government can encourage consumers to purchase an electric vehicle, and provide a charging reward to the electric vehicle owner's account to provide a charging discount.

First, in step S910, it is determined whether the electric vehicle or the owner of the electric vehicle meets a predetermined identity based on the identification data. In some embodiments, step S910 may determine whether the electric vehicle or the owner of the electric vehicle is the payment object of the government's charging rewards. When the electric vehicle or the owner of the electric vehicle does not meet the predetermined identity (No in step S920), the flow ends. In other words, no account offset operation is performed. When the electric vehicle or the owner of the electric vehicle meets the predetermined identity (Yes in step S920), in step S930, a stored value database is searched according to the identification data to obtain an account balance corresponding to the identification data. Next, in step S940, the charging fee for the charging operation is deducted from the account balance until the account balance becomes zero. Then, in step S950, a compensation content of the E-mobility service provider is calculated based on the charging fee of the identification data. In other words, in the aforementioned example of government charging rewards, the charging fee of the owner of the electronic vehicle will be paid by the government to the E-mobility service provider of the owner of the electronic vehicle through the compensation content.

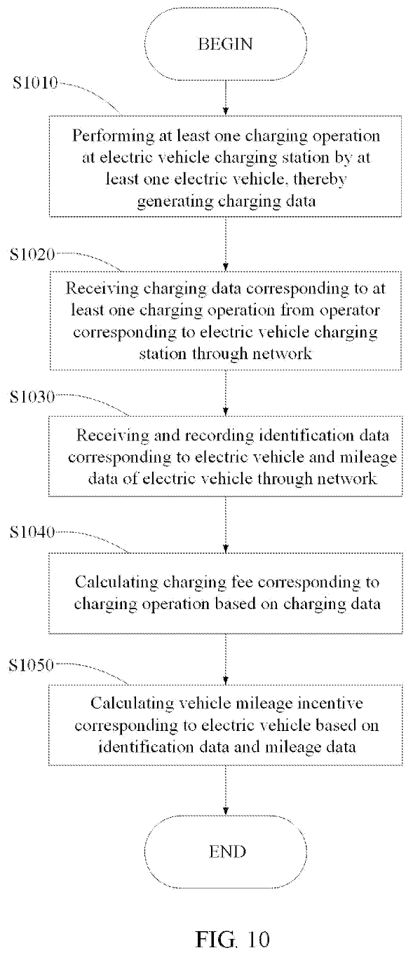

FIG. 10 is a flowchart of another embodiment of a charging management method for electric vehicle charging stations of the invention. The charging management method for electric vehicle charging stations of the invention can be applied to a server of a charging roaming management platform.

First, in step S1010, at least one electric vehicle performs at least one charging operation at an electric vehicle charging station, thereby generating at least one charging data. Similarly, in some embodiments, the charging data may include related data of the corresponding charging point operator and electric vehicle charging station, the charging power quantity corresponding to the charging operation, charging time interval, charging period, and/or demand response execution status, and so on. It should be noted that the aforementioned charging data is only example, and the invention is not limited thereto. Thereafter, in step S1020, the at least one charging data corresponding to the at least one charging operation is received from the operator corresponding to the electric vehicle charging station through a network, and in step S830, a charging fee is calculated based on the at least one charging data. Next, in step S1030, identification data corresponding to the electric vehicle and mileage data of the electric vehicle are received and recorded through the network. It should be noted that, in some embodiments, the identification data and mileage data of the electric vehicle can be received from the E-mobility service provider through the network. Then, in step S1040, a charging fee corresponding to the charging operation is calculated based on the charging data, and in step S1050, a vehicle mileage reward corresponding to the electric vehicle is calculated based on the identification data and the mileage data. It should be noted that, in some examples, the government can encourage operators to purchase electric vehicles, such as electric buses, and encourage operators to actually drive electric buses, and provide operators with mileage rewards based on the actual mileage traveled.

Therefore, through the charging management method and system for electric vehicle charging stations of the invention, the analysis and reward calculation can be carried out according to the usage status of the electric vehicle charging station, thereby providing effective monitoring and management tools, calculating the rewards according to the usage indices, and then increasing the utilization rate of electric vehicle charging stations and electric vehicles, so as to achieve the good intention of policy subsidies, and make follow-up policy adjustments accordingly.

Charging management methods for electric vehicle charging stations, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A charging management method for electric vehicle charging stations for use in a server, comprising:
performing at least one charging operation at an electric vehicle charging station by at least one electric vehicle, thereby generating at least one charging data;
receiving the at least one charging data corresponding to the at least one charging operation through a network; and
analyzing a usage index corresponding to the electric vehicle charging station according to the at least one charging data.

2. The method of claim 1, further comprising calculating a charging station usage reward for a charging point operator (CPO) corresponding to the electric vehicle charging station based on the usage index.

3. The method of claim 2, wherein the at least one charging data is received by the charging point operator through the network, and the server belongs to a charging roaming management platform.

4. The method of claim 1, further comprising:
calculating a charging fee based on the at least one charging data;
receiving identification data corresponding to the electric vehicle or an owner of the electric vehicle through the network; and
executing an account offset operation based on the identification data, wherein the account offset operation includes the steps of:
searching a stored value database according to the identification data to obtain an account balance corresponding to the identification data; and
deducting the charging fee from the account balance until the account balance becomes zero.

5. The method of claim 4, further comprising:
determining whether the electric vehicle or the owner of the electric vehicle meets a predetermined identity based on the identification data; and
executing the account offset operation when the electric vehicle or the owner of the electric vehicle meets the predetermined identity.

6. The method of claim 4, wherein the identification data corresponding to the electric vehicle or the owner of the electric vehicle is received from an E-mobility service provider (EMSP) through the network, and the server belongs to a charging roaming management platform.

7. The method of claim 6, further comprising calculating a compensation content of the E-mobility service provider based on the charging fee of the identification data.

8. The method of claim 1, wherein the usage index comprises a usage status during peak hours, a usage status during off-peak hours, or an implementation status of demand response.

9. The method of claim 1, further comprising:
receiving identification data corresponding to the electric vehicle through the network;
receiving and recording mileage data of the electric vehicle through the network; and
calculating a vehicle mileage reward corresponding to the electric vehicle based on the identification data and the mileage data.

10. A charging management system for electric vehicle charging stations, comprising:
an electric vehicle charging station providing at least one electric vehicle to perform at least one charging operation, thereby generating at least one charging data; and
a server receiving the at least one charging data corresponding to the at least one charging operation through a network, and analyzing a usage index corresponding to the electric vehicle charging station according to the at least one charging data.

11. The system of claim 10, wherein the server further calculates a charging station usage reward for a charging point operator (CPO) corresponding to the electric vehicle charging station based on the usage index.

12. The system of claim 11, wherein the at least one charging data is received by the charging point operator through the network, and the server belongs to a charging roaming management platform.

13. The system of claim 10, wherein the server further calculates a charging fee based on the at least one charging data, receives identification data corresponding to the electric vehicle or an owner of the electric vehicle through the network, and executes an account offset operation based on the identification data, wherein the account offset operation includes the steps of searching a stored value database according to the identification data to obtain an account balance corresponding to the identification data, and deducting the charging fee from the account balance until the account balance becomes zero.

14. The system of claim 13, wherein the server further determines whether the electric vehicle or the owner of the electric vehicle meets a predetermined identity based on the identification data and executes the account offset operation when the electric vehicle or the owner of the electric vehicle meets the predetermined identity.

15. The system of claim 13, wherein the identification data corresponding to the electric vehicle or the owner of the electric vehicle is received from an E-mobility service provider (EMSP) through the network, and the server belongs to a charging roaming management platform.

16. The system of claim 15, wherein the server further calculates a compensation content of the E-mobility service provider based on the charging fee of the identification data.

17. The system of claim 10, wherein the usage index comprises a usage status during peak hours, a usage status during off-peak hours, or an implementation status of demand response.

18. The system of claim 10, wherein the server further receives identification data corresponding to the electric vehicle through the network, receives and records mileage data of the electric vehicle through the network, and calculates a vehicle mileage reward corresponding to the electric vehicle based on the identification data and the mileage data.

19. A machine-readable storage medium comprising a computer program, which, when executed, causes a device to perform a charging management method for electric vehicle charging stations, wherein the method comprises:
performing at least one charging operation at an electric vehicle charging station by at least one electric vehicle, thereby generating at least one charging data;
receiving the at least one charging data corresponding to the at least one charging operation through a network; and
analyzing a usage index corresponding to the electric vehicle charging station according to the at least one charging data.
